(19) United States
(12) Patent Application Publication
(10) Pub. No.: US 2020/0346837 A1
(43) Pub. Date: Nov. 5, 2020

(54) NON-TOXIC BIODEGRADABLE TREATMENT PRODUCT

(71) Applicant: William Lee Lamb, III, Odenton, MD (US)

(72) Inventor: William Lee Lamb, III, Odenton, MD (US)

(21) Appl. No.: 16/401,493

(22) Filed: May 2, 2019

(51) Int. Cl. B65D 81/26; B65D 81/28; B01J 20/12

(52) U.S. Cl. CPC B65D 81/264; B65D 81/268; A01N 65/00; B01J 20/12; B65D 81/28

(57) ABSTRACT

A product for improving the environment of a confined space includes an enclosed oblong housing formed of a semipermeable material having a non-toxic blend of ingredients arranged therein. The housing has an oval side wall and a substantially flat bottom wall. A tab containing an opening extends outwardly from an upper portion of the housing for hanging the product rather than sitting it on its bottom wall.

### BACKGROUND OF THE DISCLOSURE

The present disclosure relates to a product for improving the environment of a confined space by controlling moisture and odor and inhibiting microbial and fungal growth of the space.

Similar products, for instance traditional desiccant packs filled with silica gel beads or leaded bentonite clay, are used for moisture control. These products are readily available and are used in packing goods, electronics, and other items that are enclosed in confined spaces that require moisture control. They are typically formed as a flat, rectangular package that includes a semipermeable material to allow the material within the package to absorb water. The packaging is unattractive, and the product is typically used once and then discarded.

Many of the above-noted desiccant packs with silica gel beads include other ingredients. These ingredients might improve the absorption properties of the package or provide other characteristics, for instance, they might change color to indicate whether a package has absorbed a specific level of liquid. This can let a user know that the package has reached its absorption potential and a new package will be needed to continue to control moisture. The additional ingredients used in such packages can often result in a product that is toxic if digested. Further, many of the known moisture control products are often not recyclable and have limited use. Such products do not control odor, do not inhibit mold or microbial growth, and do not discourage insect infestations.

Thus, there is a need for a new product that can control moisture, microbial and fungal growth as well as possible insect infestations in stored and packaged goods. Such a product should provide greater rates of moisture control, have a more attractive appearance and aroma, and be reusable.

### SUMMARY OF THE DISCLOSURE

Accordingly, it is an object of the present disclosure to provide a product for improving the environment of a confined space, including an enclosed oblong housing formed of a semipermeable material having a non-toxic blend of ingredients arranged therein. Preferably, the housing has an oval side wall and a substantially flat bottom wall. The non-toxic blend of ingredients have properties to control moisture and odor and to inhibit microbial and fungal growth of the confined space, which might include a combination of bentonite clay, thyme, baking soda, cinnamon, or clove. Preferably, the semipermeable material is a synthetic high-density polyethylene material, such as the material used with Tyvek® brand fibrous products.

In a separate embodiment, the housing bottom wall includes a lip arranged at an outer edge to improve stability of the product when sitting in an upright position.

In yet another embodiment, the product includes a tab extending outwardly from an upper portion of the housing. The tab contains an opening for hanging the product rather than sitting it on its bottom wall.

### BRIEF DESCRIPTION OF THE FIGURES

Other objects and advantages of the disclosure will become apparent from a study of the following specification when viewed in the light of the accompanying drawing, in which:

FIG. 1 is a front view of a first embodiment of a product according to the present disclosure;

FIG. 2 is a perspective view of second embodiment of a product for improving the environment of a confined space according to the present disclosure;

FIG. 3 is a front view of yet an embodiment of a product for improving the environment of a confined space according to the present disclosure; and

FIG. 4 is a blend of ingredients that are used with the products of the present disclosure;

### DETAILED DESCRIPTION

The present disclosure describes an inexpensive, visually distinct product that controls moisture and odor, inhibits microbial and fungal growth, and reduces insect infestations in product packaging, storage boxes, drawers, closets or any confined space that needs environmental controls to keep items fresh and clean. The product also has multiple ancillary uses and benefits, and further, can include an image and/or business branding imprinted on the outer material.

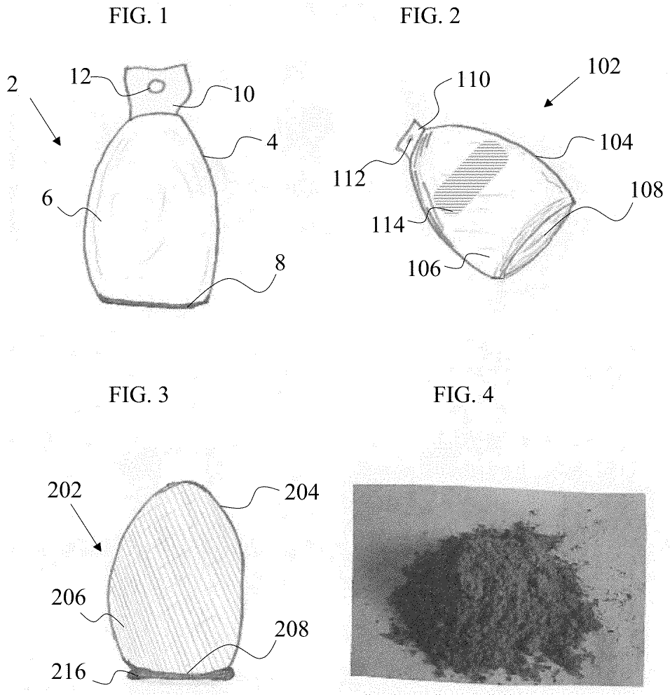

Referring first to FIG. 1, there is a product 2 for improving the environment of a confined space, which includes an enclosed oblong housing 4 formed of a semipermeable material having a non-toxic blend of ingredients arranged therein. The housing has an oval side wall 6 and a substantially flat bottom wall 8. There is a tab 10 extending outwardly from an upper portion of the housing 4. The tab contains an opening 12 for hanging the product rather than sitting it on its bottom wall.

FIG. 2 shows an alternate embodiment of a product 102 for improving the environment of a confined space. As with the product in FIG. 1, the embodiment of FIG. 2 includes an enclosed oblong housing 104 having an oval side wall 106 a substantially flat bottom wall 108, and a tab 110 containing an opening 112. In addition to those elements, the product includes a pad 114 for use in cleaning delicate items, for instance, a screen, phone, glasses, or other such item. The pad is preferably made of a microfiber material and attached to the product housing side wall 106 such as via stitching or an adhesive. The pad of FIG. 2 has a generally rectangular configuration and covers a central portion of the housing side wall. It will be understood by those with skill in the art that other configurations and locations can be implemented. For instance, the pad could be attached to any portion of the side wall and cover a larger or smaller surface area. The pad might be circular, triangular, or another polygonal shape. Rather than attaching the pad with the side wall, it could be attached with the bottom wall 108.

FIG. 3 shows yet another embodiment of a product 202 for improving the environment of a confined space. The product includes an enclosed oblong housing 204 having an oval side wall 206 and a substantially flat bottom wall 208. Unlike the embodiment of FIGS. 1 and 2, the upper portion of the housing does not include a tab having an opening. Rather, the bottom wall 208 includes a lip 216 arranged at and extending outwardly from an outer edge of the wall to improve stability of the product when sitting in its upright position. Additionally, the semipermeable housing 204 of FIG. 3 is a synthetic high-density polyethylene material. Preferably, Tyvek® brand fibrous material is used to form the housing. However, it will be understood by those with skill in the art that other semipermeable type materials could be used.

FIG. 4 is one example of the non-toxic blend of ingredients included within the oblong housing of the embodiments discussed above. The ingredients have properties to control moisture and odor and to inhibit microbial and fungal growth of the confined space. Such ingredients include a combination of bentonite clay, thyme, baking soda, cinnamon, or clove. In a preferred embodiment, the ingredients include 5-95% for each of bentonite clay, thyme oil powder, baking soda powder, cinnamon powder, and clove oil powder.

As noted above, the ingredients are cased in the semipermeable, printable oblong-shaped wrapper with a flat bottom. Each ingredient is non-toxic, provides a pleasant aroma, and can have additional uses, for instance as a skin care product.

Bentonite clay is a hydroscopic material that absorbs water at rates that are the same or better than silica gel beads. However, the configuration of the product disclosed herein provides a greater surface area than the standard desiccant packs, and thus the total absorption rates of the products of the present disclosure are greater than with those packs. The remaining ingredients further control moisture and/or inhibit microbial and fungal growth. Thyme oil is antiseptic, bactericidal, and an insecticide. Baking soda has moisture and odor absorbing properties as well as many skin care attributes. Cinnamon contains antibiotic, antimicrobial, antiviral, and antifungal properties. Lastly, clove oil has antimicrobial, antifungal, antiseptic, antiviral, aphrodisiac and stimulating properties.

Normal desiccant packs only control moisture. They have no anti-fungal, anti-microbial, insect repelling or anti-odor properties. A standard desiccant package is square and unattractive. The product of the present disclosure can sit upright to provide a visually striking item. The non-toxic, all-natural ingredients housed within the product are safe if accidentally ingested and are all natural and biodegradable. When stored in contained areas such as boxes, drawers, sealed areas, or closets, the product controls moisture as well as odor, fungal or microbial growth or insect infestations.

Beyond the uses noted above, the presently disclosed product can also be used as a soap substitute, a dish scrubber, a bug repellent, a salve for burns, insect bites, abrasions, stings, rashes and many other irritating maladies. It can also be used in shoes, refrigerators or numerous other places as an odor absorber. The internal contents can be wetted and used as a face mask, salve or balm due to the above-noted skin care attributes of the ingredients. The product can be baked and reactivated for multiple uses once it has absorbed a significant amount of moisture, or if it was heavily wetted for its noted ancillary uses.

The product housing may include imaging that will be displayed when the product is sitting upright or is hung from its tab. That could include a generic image, creative cover art, or even a specific brand for use as a marketing.

Although the above description with reference to particular embodiments, it is to be understood that these embodiments are merely illustrative of the principles and applications of the present disclosure. It is therefore to be understood that numerous modifications may be made to the illustrative embodiments and that other arrangements may be devised and employed without departing from the spirit and scope of the present disclosure.

What is claimed is:

1. A product for improving the environment of a confined space, comprising:
a. an enclosed oblong housing formed of a semipermeable material and having a side wall and a bottom wall, said bottom wall having a substantially flat configuration; and
b. a non-toxic blend of ingredients arranged within said housing, said ingredients having properties to control moisture and odor and to inhibit microbial and fungal growth of the confined space.

2. A product as defined in claim 1, wherein said housing side wall has a substantially oval configuration.

3. A product as defined in claim 1, wherein said housing bottom wall includes a lip arranged at an outer edge.

4. A product as defined in claim 1, and further comprising a tab extending outwardly from an upper portion of said housing and containing an opening for hanging said product.

5. A product as defined in claim 1, wherein said semipermeable material comprises a synthetic high-density polyethylene material.

6. A product as defined in claim 1, wherein said non-toxic blend includes at least one of bentonite clay, thyme, baking soda, cinnamon, and clove.

7. A product as defined in claim 6, where said non-toxic blend includes at least 5-95% of one of bentonite clay, thyme oil powder, baking soda powder, cinnamon powder, and clove oil powder.

8. A product as defined in claim 1, and further comprising a pad attached to said housing side wall.

9. A product as defined in claim 8, wherein said pad comprises a microfiber material.
